(19) United States
(12) Patent Application Publication
(10) Pub. No.: US 2008/0244715 A1
(43) Pub. Date: Oct. 2, 2008

(54) Method and apparatus for detecting and reporting phishing attempts

(76) Inventor: Tim Pedone, San Diego, CA (US)

Correspondence Address: PVF -- INTUIT, INC.;c/o PARK, VAUGHAN & FLEMING LLP, 2820 FIFTH STREET, DAVIS, CA, 95618-7759, US

(21) Appl. No.: 11/729,077

(22) Filed: Mar. 27, 2007

(51) Int. Cl. H04L 9/32

(52) U.S. Cl. 726/5

(57) ABSTRACT

One embodiment of the present invention provides a system that facilitates detecting phishing, wherein phishing is an attempt to fraudulently acquire sensitive information by masquerading as a legitimate entity. The system operates by receiving data from a server at a client. Next, the system determines if an attribute (such as a visual appearance of a presentation) encoded in the data matches an attribute encoded in data provided by a known entity. If so, the system determines if other attributes in the data match attributes in the data provided by the known entity. If not, the system determines that the data comprises a phishing attempt.

### BACKGROUND

### Related Art

In order to provide better service to their clients, businesses and organizations are beginning to provide their clients with the ability to access sensitive information online. However, providing this ability makes it possible for unscrupulous individuals to fraudulently obtain this sensitive information. In particular, a number of “phishing” techniques have been developed to fraudulently obtain sensitive information, for example, by masquerading a fake website as a legitimate website, or by masquerading a fake email as a legitimate email. The goal of phishing is to trick a user into providing sensitive information, or to trick a user into providing credentials to access sensitive information.

In order to combat phishing, some companies and organizations use personal information, such as a picture or a private piece of data, to confirm that their communications are legitimate. If a web site or an email does not contain this personal information, then the web site or email is likely to be part of a phishing attempt. However, this technique has drawbacks. For example, this technique requires the user to remember to look for the personal information before interacting with the web site or email.

### SUMMARY

One embodiment of the present invention provides a system that facilitates detecting phishing, wherein phishing is an attempt to fraudulently acquire sensitive information by masquerading as a legitimate entity. The system operates by receiving data from a server at a client. Next, the system determines if a code within the data matches a code within data provided by a known entity. If so, the system determines if other attributes in the data match attributes in the data provided by the known entity. If not, the system determines that the data comprises a phishing attempt.

In some embodiments of the present invention, the code within the data includes code that generates visual elements.

In some embodiments of the present invention, the code that generates visual elements includes HyperText Markup Language (HTML), extensible Markup Language (XML), or any other language capable of generating visual elements.

In some embodiments of the present invention, if it is determined that the data comprises a phishing attempt, the system notifies the known entity that a phishing attempt was detected.

In some embodiments of the present invention, receiving the data from the server at the client involves receiving data from a web server in a web browser.

In some embodiments of the present invention, if it is determined that the data comprises a phishing attempt, the system notifies the user that the data comprises a phishing attempt.

In some embodiments of the present invention, receiving the data from the server at the client involves receiving the data from an email server at an email client.

In some embodiments of the present invention, after notifying the user that the data comprises a phishing attempt, the system receives a command from the user, wherein the command can include: instructing the web browser to abort loading the data; instructing the web browser to continue loading the data; or instructing the web browser to load the known “good” data (i.e., redirecting the browser to the appropriate legitimate web site).

In some embodiments of the present invention, the other attributes can include: a digital certificate, a visual appearance, a digital watermark, an image recognition signature, a token, an Internet Protocol (IP) address, a Uniform Resource Locator (URL), and any other attribute that can serve to differentiate data from an authentic entity from data of a phishing entity.

In some embodiments of the present invention, the process of determining if the other attributes of the data match attributes of the known entity can take place at: a web browser, a web browser plug-in, an email client, an email client plug-in, an email server, a standalone application, a service executing on the client, a proxy server coupled between the server and the client, or any other computing system application capable of performing the attribute match.

In some embodiments of the present invention, the system receives a response from the user indicating that the data is suspected to comprise a phishing attempt. In response to the request, the system notifies the known entity, and/or the user that a phishing attempt has been detected.

In some embodiments of the present invention, the system periodically updates a database containing data associated with known entities.

### BRIEF DESCRIPTION OF THE FIGURES

FIG. 1 illustrates a computing environment in accordance with an embodiment of the present invention.

FIG. 2 presents a flowchart illustrating the process of detecting a phishing attempt in accordance with an embodiment of the present invention.

FIG. 3 presents a flowchart illustrating the process of dealing with a detected phishing attempt in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention provides a system that facilitates detecting phishing, wherein phishing is an attempt to fraudulently acquire sensitive information by masquerading as a legitimate entity. For example, a malicious individual may attempt to “phish” a user's online banking username and password by sending an email to the user, wherein the email looks like an official email that originates from the user's banking institution. Furthermore, the email may direct the user to a website that looks the same as the official site of the banking institution.

During operation, the system receives data from a server at a client. Next, the system determines if an attribute (such as a visual appearance of a presentation) encoded in the data matches an attribute encoded in data provided by a known entity. If so, the system determines if other attributes in the data match attributes in the data provided by the known entity. If not, the system determines that the data comprises a phishing attempt.

In some embodiments of the present invention, the code within the data includes code that generates visual elements.

In some embodiments of the present invention, the code that generates visual elements includes HyperText Markup Language (HTML), eXtensible Markup Language (XML), or any other language capable of generating visual elements.

In some embodiments of the present invention, if it is determined that the data comprises a phishing attempt, the system notifies the known entity that a phishing attempt was detected. For example, if the system determines that the data comprises a phishing attempt to obtain a user's online banking information, the system may notify the user's bank, and may forward the details of the phishing attempt to the user's bank. In another embodiment of the present invention, the system notifies a third-party.

In some embodiments of the present invention, receiving the data from the server at the client involves receiving the data from an email server at an email client.

In some embodiments of the present invention, receiving the data from the server at the client involves receiving data from a web server in a web browser.

In some embodiments of the present invention, if it is determined that the data comprises a phishing attempt, the system notifies the user that the data comprises a phishing attempt.

In some embodiments of the present invention, after notifying the user that the data comprises a phishing attempt, the system receives a command from the user, wherein the command can include: instructing the web browser to abort loading the data; instructing the web browser to continue loading the data; or instructing the web browser to load the known “good” data. For example, if the user is surfing the web and navigates to a web page that he or she believes to be his or her online auction site, and if the system determines that the site is a possible phishing site, the system can present the user with a modal dialog that requires the user to make a choice before any other action is taken. Possible choices can include: closing the web browser; redirecting the web browser to a benign site; redirecting the web browser to the legitimate site to which the system determined the user was trying to navigate; and continuing on to the suspected phishing site.

In some embodiments of the present invention, the other attributes can include: a digital certificate, a visual appearance, a digital watermark, an image recognition signature, a token, an Internet Protocol (IP) address, a Uniform Resource Locator (URL), and any other attribute that can serve to differentiate data from an authentic entity from data of a phishing entity.

In some embodiments of the present invention, the process of determining if the other attributes of the data match attributes of the known entity takes place at one of: a web browser, a web browser plug-in, an email client, an email client plug-in, an email server, a standalone application, a service executing on the client, a proxy server coupled between the server and the client, or any other computing system application capable of performing the attribute match.

In some embodiments of the present invention, the system receives a response from the user indicating that the data is suspected to comprise a phishing attempt. In response to the request, the system notifies the known entity and/or the user that a phishing attempt has been detected.

In some embodiments of the present invention, the system periodically updates a database containing data associated with known entities.

### Computing Environment

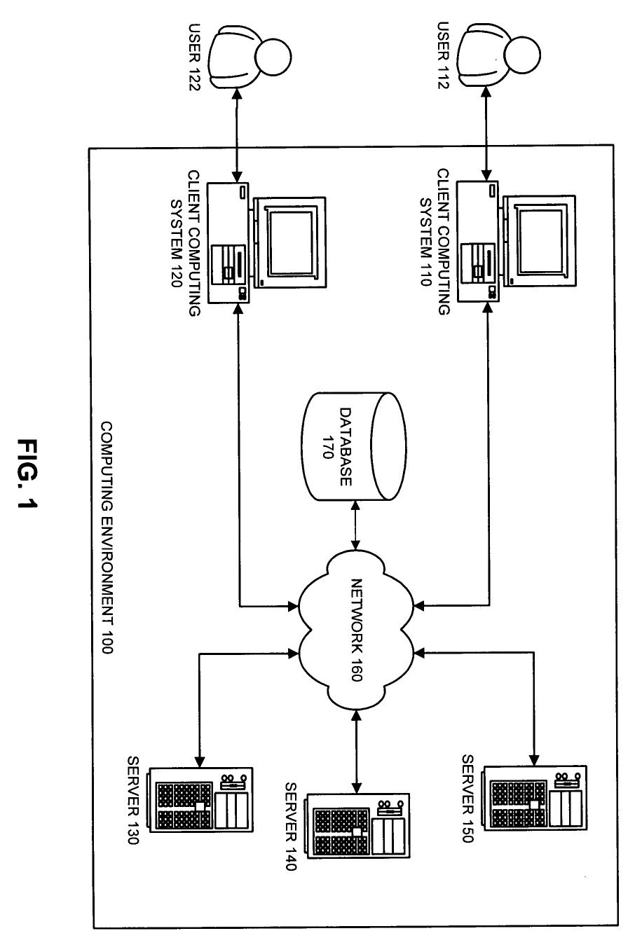

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, computing environment 100 includes client computing system 110, client computing system 120, server 130, server 140, server 150, network 160, and database 170.

Client computing system 110 and client computing system 120 can generally include any node on a network including computational capability and including a mechanism for communicating across the network.

Servers 130-150 can generally include any system capable of hosting and/or running a service that is accessible from network 160. Furthermore, servers 130-150 can generally include any nodes on a computer network including a mechanism for servicing requests from a client for computational and/or data storage resources.

User 112 and user 122 can generally include: an individual; a group of individuals; an organization; a group of organizations; a computing system; a group of computing systems; or any other entity that can interact with computing environment 100.

Network 160 can generally include any type of wired or wireless communication channel capable of coupling together computing nodes. This includes, but is not limited to, a local area network, a wide area network, or a combination of networks. In one embodiment of the present invention, network 160 includes the Internet.

Database 170 can include any type of system for storing data in non-volatile storage. This includes, but is not limited to, systems based upon magnetic, optical, or magneto-optical storage devices, as well as storage devices based on flash memory and/or battery-backed up memory.

In one embodiment of the present invention, a user 112 operates client computing system 110 to access sensitive information from server 130. Consider the example where user 112 accidentally mistyped the Uniform Resource Locator (URL) for the site that he or she wanted to access, and instead of connecting to server 130 as intended, user 112 was actually connected to server 140. Also suppose that server 140 includes a phishing website that was created by user 122 to masquerade as the legitimate website being served by server 130.

In this example, when user 112 connects to server 140, the system analyzes the data being sent to client computing system 110 from server 140 to determine the visual appearance of a presentation encoded in the data. For example, if the data includes HyperText Markup Language (HTML) code that is being sent to a browser on client computing system 110, the system analyzes the HTML code, as well as the images referenced by the HTML code, to determine the visual appearance of the web page being sent to the browser on client computing system 110.

Next, the system checks the visual appearance of the web page against a database of appearances for known entities, such as database 170. Note that database 170 can be included on client computing system 110, or can be accessed by client computing system 110 via network 160. In some embodiments of the present invention, database 170 is coupled to an anti-phishing service running on server 150, and a cached copy of database 170 is stored locally on client computing system 110.

If the visual appearance of the web page being sent from server 140 to client computing system 110 matches the visual appearance of a known entity, such as the visual appearance of the web site being served by server 130, then the system determines if other attributes in the data match attributes in the data provided by the known entity. For example, the system determines if the IP address of server 140 matches the IP address associated with the visual presentation of the known entity, server 130. If not, the system determines that the data comprises a phishing attempt and takes appropriate action.

Note that the other attributes in the data are not limited to IP addresses, but can include: a digital certificate, a Uniform Resource Locator (URL), as well as any other attribute that can be used to determine the identity of the data.

In some embodiments of the present invention, if the system determines that the data comprises a phishing attempt, the system notifies the known entity, server 130 in this example, of the phishing attempt. The system also notifies user 112 of the phishing attempt. This can involve presenting user 112 with options of how to proceed. For example, the system may give user 112 the option to: continue to display the data originating from server 140; to redirect the browser on client computing system 110 to connect to the known entity (server 130); to close the browser on client computing system 110; or any other action that can be performed on client computing system 110. In one embodiment of the present invention, the system stores the origin of the phishing attempt, server 140, as a known phishing source in database 170. This facilitates subsequently identifying server 140 as a known phishing source.

In another embodiment of the present invention, the system analyzes email messages as they arrive at client computing system 110 to determine if the data within the email messages comprise a phishing attempt. In some embodiments of the present invention, the system analyzes instant messages that arrive at client computing system 110 to determine if the data within the instant messages comprise a phishing attempt.

In some embodiments of the present invention, the process of determining if the other attributes of the data match attributes of the known entity, to determine if the data comprises a phishing attempt, takes place at a web browser running on client computing system 110. In some embodiments of the present invention, this process takes place in a web browser plug-in. In some embodiments of the present invention, this process can take place: in an email client, an email client plug-in, a standalone application, a service executing on client computing system 110, or a proxy server coupled between the source of the data and client computing system 110.

In one embodiment of the present invention, this process can take place on an email server that serves email to client computing system 110.

### Detecting a Phishing Attempt

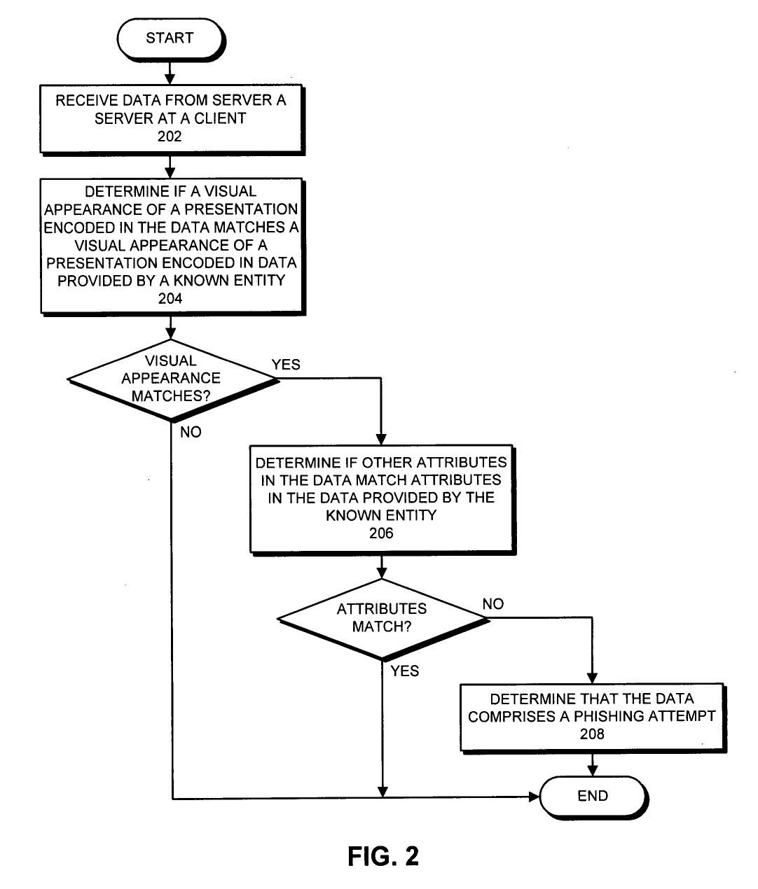

FIG. 2 presents a flowchart illustrating the process of detecting a phishing attempt in accordance with an embodiment of the present invention.

The system operates by receiving data from a server at a client (operation 202). Next, the system determines if a visual appearance of a presentation encoded in the data matches a visual appearance of a presentation encoded in data provided by a known entity (operation 204). For example, if the data is HyperText Markup Language (HTML) code that is being sent to a browser on client computing system 110, the system analyzes the HTML code, as well as the images referenced by the HTML code, to determine the visual appearance of the web page being sent to the browser on client computing system 110. The system then determines if the resulting appearance from rendering the HTML matches a known appearance stored in database 170. If so, the system determines if other attributes in the data match attributes in the data provided by the known entity (operation 206). Note that these attributes can include IP addresses, digital certificates, and URLs, as well as any other attribute that can be used to determine the identity of the data. If not, the system determines that the data comprises a phishing attempt (operation 208).

Dealing with a Detected Phishing Attempt

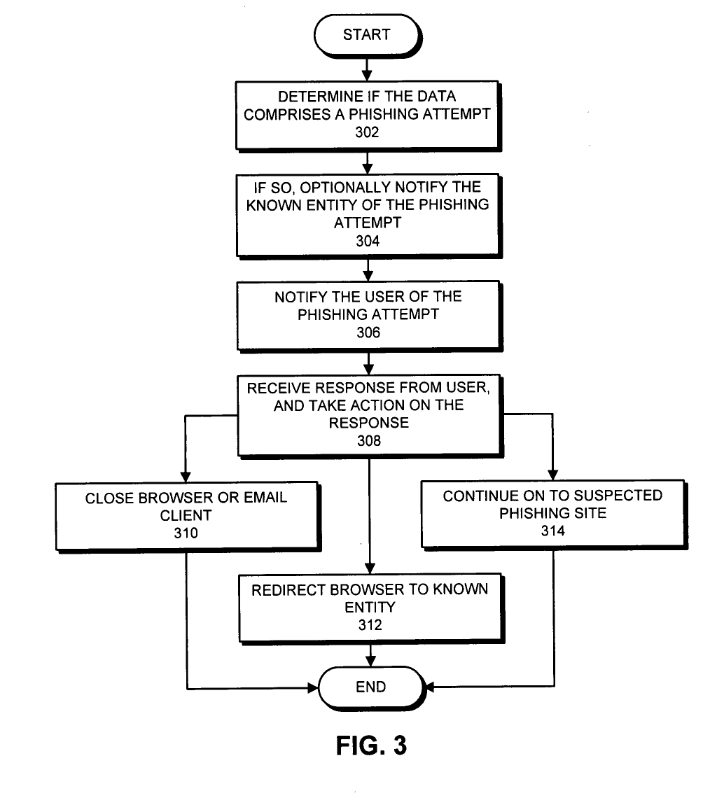

FIG. 3 presents a flowchart illustrating the process of dealing with a detected phishing attempt in accordance with an embodiment of the present invention. In some embodiments of the present invention, if it is determined that the data comprises a phishing attempt (operation 302), the system optionally notifies the known entity that a phishing attempt was detected (operation 304). For example, if the system determines that the data comprises a phishing attempt to obtain a user's online banking information, the system may notify the user's bank, as well as forwarding the details of the phishing attempt to the user's bank. In another embodiment of the present invention, the system notifies a third-party.

The system also notifies the user about the phishing attempt (operation 306), and then receives a response from the user, and takes action on the response (operation 308). This action can include closing the browser or email client (operation 310), redirecting the browser to the known entity (operation 312), or continuing on to the suspected phishing site (operation 314). Note that other actions may be taken besides those listed here.

### Summary

Embodiment of the present invention provides a system that facilitates detecting phishing, wherein phishing is an attempt to fraudulently acquire sensitive information by masquerading as a legitimate entity. The system operates by receiving data from a server at a client. Next, the system determines if a visual appearance of a presentation encoded in the data matches a visual appearance of a presentation encoded in data provided by a known entity. If so, the system determines if other attributes in the data match attributes in the data provided by the known entity. If not, the system determines that the data comprises a phishing attempt.

In some embodiments of the present invention, if it is determined that the data comprises a phishing attempt, the system notifies the known entity that a phishing attempt was detected. For example, if the system determines that the data comprises a phishing attempt to obtain a user's online banking information, the system may notify the user's bank, as well as forwarding the details of the phishing attempt to the user's bank. In another embodiment of the present invention, the system notifies a third-party.

Embodiments of the present invention actively determine if the data being sent to the user comprises a phishing attempt rather than relying on actions of and/or knowledge of the user.

In some embodiments of the present invention, the database of known sites is updated regularly, and users may choose to subscribe to an update service to ensure that they have the latest updates.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for detecting phishing, wherein phishing is an attempt to fraudulently acquire sensitive information by masquerading as a legitimate entity, the method comprising:
receiving data from a server at a client;
determining if a code within the data matches a code within data provided by a known entity;
if so, determining if other attributes in the data match attributes in the data provided by the known entity; and
if not, determining that the data comprises a phishing attempt.

2. The method of claim 1, wherein the code within the data includes code that generates visual elements.

3. The method of claim 2, wherein the code that generates visual elements includes HyperText Markup Language (HTML) or eXtensible Markup Language (XML).

4. The method of claim 1, wherein if it is determined that the data comprises a phishing attempt, the method further involves notifying the known entity that a phishing attempt was detected.

5. The method of claim 1, wherein receiving the data from the server at the client involves receiving the data from an email server at an email client.

6. The method of claim 1, wherein receiving the data from the server at the client involves receiving data from a web server in a web browser.

7. The method of claim 5, wherein if it is determined that the data comprises a phishing attempt, the method further involves notifying the user that the data comprises a phishing attempt.

8. The method of claim 7, wherein after notifying the user that the data comprises a phishing attempt, the method further involves receiving a command from the user, wherein the command includes at least one of:
instructing the web browser to abort loading the data;
instructing the web browser to continue loading the data; and
instructing the web browser to load the known data.

9. The method of claim 1, wherein the other attributes includes at least one of:
a digital certificate;
a visual appearance;
a digital watermark;
a token;
an image recognition signature;
an Internet Protocol (IP) address; and
a Uniform Resource Locator (URL).

10. The method of claim 1, wherein the process of determining if the other attributes of the data match attributes of the known entity takes place at one of:
a web browser;
a web browser plug-in;
an email client;
an email client plug-in;
an email server;
a standalone application;
a service executing on the client; and
a proxy server coupled between the server and the client.

11. The method of claim 1, further comprising:
receiving a response from the user indicating that the data is suspected to comprise a phishing attempt; and
in response to the request, notifying the known entity that a phishing attempt has been detected.

12. The method of claim 1, further comprising periodically updating a database containing data associated with known entities.

13. A computer-readable storage medium storing instructions that when executed by a computer cause the computer to perform a method for detecting phishing, wherein phishing is an attempt to fraudulently acquire sensitive information by masquerading as a legitimate entity, the method comprising:
receiving data from a server at a client;
determining if a code within the data matches a code within data provided by a known entity;
if so, determining if other attributes in the data match attributes in the data provided by the known entity; and
if not, determining that the data comprises a phishing attempt.

14. The method of claim 13, wherein the code within the data includes code that generates visual elements.

15. The method of claim 14, wherein the code that generates visual elements includes HyperText Markup Language (HTML) or extensible Markup Language (XML).

16. The computer-readable storage medium of claim 13, wherein if it is determined that the data comprises a phishing attempt, the method further involves notifying the known entity that a phishing attempt was detected.

17. The computer-readable storage medium of claim 13, wherein receiving the data from the server at the client involves receiving the data from an email server at an email client.

18. The computer-readable storage medium of claim 13, wherein receiving the data from the server at the client involves receiving data from a web server in a web browser.

19. The computer-readable storage medium of claim 18, wherein if it is determined that the data comprises a phishing attempt, the method further involves notifying the user that the data comprises a phishing attempt.

20. The computer-readable storage medium of claim 19, wherein after notifying the user that the data comprises a phishing attempt, the method further involves receiving a command from the user, wherein the command includes at least one of:
instructing the web browser to abort loading the data;
instructing the web browser to continue loading the data; and
instructing the web browser to load the known data.

21. The computer-readable storage medium of claim 13, wherein the other attributes includes at least one of:
a digital certificate;
a visual appearance;
a digital watermark;
a token;
an image recognition signature;
an Internet Protocol (IP) address; and
a Uniform Resource Locator (URL).

22. The computer-readable storage medium of claim 13, wherein the process of determining if the other attributes of the data match attributes of the known entity takes place at one of:
a web browser;
a web browser plug-in;
an email client;
an email client plug-in;
an email server;
a standalone application;
a service executing on the client; and
a proxy server coupled between the server and the client.

23. The computer-readable storage medium of claim 13, wherein the method further comprises:
receiving a response from the user indicating that the data is suspected to comprise a phishing attempt; and
in response to the request, notifying the known entity that a phishing attempt has been detected.

24. The computer-readable storage medium of claim 13, wherein the method further comprises periodically updating a database containing data associated with known entities.

25. An apparatus configured to detect phishing, wherein phishing is an attempt to fraudulently acquire sensitive information by masquerading as a legitimate entity, comprising:
a receiving mechanism configured to receive data from a server at a client;
a determination mechanism configured to determine if a code within the data matches a code within data provided by a known entity;
wherein the determination mechanism is further configured to determine if other attributes in the data match attributes in the data provided by the known entity if the visual appearance of the presentation encoded in the data matches the visual appearance of the presentation encoded in data provided by the known entity; and
wherein the determination mechanism is further configured to determine that the data comprises a phishing attempt if other attributes in the data do not match attributes in the data provided by the known entity.
